(19) United States
(12) Patent Application Publication
(10) Pub. No.: US 2015/0139232 A1
(43) Pub. Date: May 21, 2015

(54) Virtual Machine Data Packet Encapsulation and Decapsulation

(71) Applicants: Praveen Yalagandula, San Francisco, CA (US); Jose Renato G. Santos, Morgan Hill, CA (US); Yoshio Turner, San Francisco, CA (US)

(72) Inventors: Praveen Yalagandula, San Francisco, CA (US); Jose Renato G. Santos, Morgan Hill, CA (US); Yoshio Turner, San Francisco, CA (US)

(21) Appl. No.: 14/400,373

(22) PCT Filed: Jul. 31, 2012
(86) PCT No.: PCT/US2012/048959

§ 371 Date: Nov. 11, 2014

(51) Int. Cl. H04L 29/06; H04L 12/741

(52) U.S. Cl. CPC H04L 69/22; H04L 45/74
USPC 370/392

(57) ABSTRACT

According to an example, a method for virtual machine (VM) data packet encapsulation and decapsulation may include receiving a data packet including a media access control (MAC) header and an internet protocol (IP) header. The method may further include encapsulating, by a processor, the received data packet to include an encapsulating MAC header, an encapsulating IP header, a VM MAC header with a same content as the MAC header of the received data packet, and a VM IP header with a same content as the IP header of the received data packet.

### BACKGROUND

Network interface cards (NICs) can implement transmission control protocol (TCP) functions in hardware using an approach generally referred to as hardware offload. Typical hardware offload functions include checksum offload and TCP segmentation offload (TSO). The checksum function is needed to ensure that TCP packets that are corrupted during transmission are discarded instead of being delivered to an application. The checksum function can address a data payload, TCP header and parts of an internet protocol (IP) header including source and destination IP addresses, packet length and protocol type.

When an application on a source host sends a large amount of data to a destination host over a TCP connection, that data can be larger than a maximum size supported by an underlying network protocol layer. Typical Ethernet networks support maximum transmission units (MTUs) of 1500 bytes, while other link protocols can have different MTU values. When an application sends data larger than the supported MTU, the TCP layer segments that data into smaller MTU sized data packets. This segmentation and use of smaller MTU sized data packets across a software network stack in a host operating system can consume considerable central processing unit (CPU) overhead. On high bandwidth networks, TSO is a technique that can be used to reduce the CPU overhead of TCP. For ISO, instead of segmenting data in software, large chunks of data are transferred to a NIC for segmentation in hardware.

On a virtualized host that includes one or more virtual machines (VMs), TSO and other functions provided by the NIC can also be beneficial. To provide address space virtualization in large cloud datacenters, the hypervisor of the virtualized host can be used to encapsulate data packets sent by VMs with layer-2 and other upper layer headers. However, if the data packets are not properly encapsulated, benefits of hardware offload techniques that are available on NICs can be negated.

### BRIEF DESCRIPTION OF DRAWINGS

Features of the present disclosure are illustrated by way of example and not limited in the following figure(s), in which like numerals indicate like elements, in which:

FIG. 1 illustrates an architecture of a virtual machine data packet encapsulation and decapsulation apparatus, according to an example of the present disclosure;

FIG. 2 illustrates an encapsulated data packet, according to an example of the present disclosure;

FIG. 3 illustrates another encapsulated data packet, according to an example of the present disclosure;

FIG. 4 illustrates a method for virtual machine data packet encapsulation and decapsulation, according to an example of the present disclosure;

FIG. 5 illustrates further details of the method for virtual machine data packet encapsulation and decapsulation, according to an example of the present disclosure; and

FIG. 6 illustrates a computer system, according to an example of the present disclosure.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

In a virtualized datacenter, data packets sent by a source virtual machine (VM) can be encapsulated by a hypervisor of a virtualized source that hosts the source VM with new headers for implementing address space virtualization. However, if the data packets are not properly encapsulated, benefits of hardware offload techniques that are available on network interface cards (NICs) can be negated. For example, NICs can perform transmission control protocol (TCP) segmentation offload (TSO), transmit checksumming, and receive checksumming. These NIC functions can reduce central processing unit (CPU) overhead that would be otherwise used by the virtualized source for transmitting data packets to a destination virtual machine hosted on a virtualized destination.

For TSO, instead of segmenting data in software, large chunks of data are transferred to a NIC along with needed header information. The NIC segments the data into maximum transmission unit (MTU) sized data packets (i.e., data packet segments) with the relevant header information. The NIC further creates the headers such that each data packet segment is a valid TCP packet that includes a sequence number. For the virtualized destination, each MTU sized data packet segment can be forwarded to the software TCP stack and then to the application independently without the need to recreate the original larger size data packet.

In addition to TSO, NICs can support checksum offload. On the transmit side, the checksum of the TCP data packet segment is computed and added to the TCP header before transmission. On the receive side, the checksum of the data packet segment is recomputed and compared with the checksum value in the data packet segment header to ensure integrity. If checksumming is not done by the NICs, checksum computation can incur significant CPU overhead at both the transmitting and the receiving sides since every byte of the TCP segment is read for checksum computation.

As discussed above, in a virtualized datacenter, data packets sent by a source VM can be encapsulated by a hypervisor of a virtualized source with new headers for implementing address space virtualization. If the new headers that are added to the data packet are not constructed correctly, TSO and checksum offload support on NICs cannot be leveraged. Instead, the hypervisor of the virtualized source will need to break the source VM data packet into data packet segments before encapsulation, and will also need to compute the data packet segment checksum at the transmitting side. Similar operations will need to be performed by the hypervisor of the virtualized destination. These operations can consume significant number of CPU cycles, which can reduce the efficiency of data packet transmission.

According to an example, a virtual machine data packet encapsulation and decapsulation apparatus and method are described. The method generally includes receiving a data packet including a media access control (MAC) header and an. Internet protocol (IP) header, and encapsulating, by a processor, the received data packet to include an encapsulating MAC header, an encapsulating IP header, a VM MAC header with the same content as the MAC header of the received data packet, and a VM IP header with the same content as the IP header of the received data packet. The method further includes placing the VM MAC header and the VM IP header after the encapsulating MAC header and the encapsulating IP header. The received data packet may be encapsulated to include a TCP header with the same content as a TCP header of the received data packet, and the VM MAC header and the VM IP header may be placed in a TCP options field of the TCP header of the encapsulated data packet. Alternatively, the VM MAC header and the VM IP header may be placed in an IP options field of the encapsulating IP header. The VM MAC header and the VM IP header may be included in data packet segments processed by a NIC, for example, in headers of the data packet segments. The encapsulated data packet may be transmitted to a NIC of a virtualized destination, for example, as processed data packet segments. In one example, the encapsulated data packet is transmitted to a NIC of a virtualized source, processed data packet segments are transmitted from the NIC of the virtualized source to a NIC of a virtualized destination, and a state-less decapsulation layer in a hypervisor of the virtualized destination is used to receive the processed data packet segments from the NIC of the virtualized destination, and to further process and transmit the processed data packet segments to a destination VM on the virtualized destination (in this case, the NIC of the virtualized destination does not combine the processed data packet segments to form the encapsulated data packet). Alternatively, the encapsulated data packet may be transmitted to a NIC of a virtualized source, the encapsulated data packet may be received from a NIC of a virtualized destination, and the encapsulated data packet may be decapsulated to replace the encapsulating MAC header with the VM MAC header, and the encapsulating IP header with the VM IP header (in this case, the NIC of the virtualized destination combines the processed data packet segments to form the encapsulated data packet). The method also includes transmitting the encapsulated data packet to a NIC of a virtualized source, transmitting a processed data packet segment from the NIC of the virtualized source to a NIC of a virtualized destination, receiving the processed data packet segment from the NIC of the virtualized destination, and transmitting the data packet segment to a destination VM on the virtualized destination independently of other processed data packet segments. The NICs for the virtualized source and destination may be used to perform hardware offload operations on the encapsulated data packet, including TSO and checksumming on the transmit side and checksumming on the receive side.

For the virtual machine data packet encapsulation and decapsulation apparatus and method, the encapsulation technique provides for leveraging of TSO and checksum offload support on NICs. Even if a data packet segment is lost, other data packet segments can be processed and delivered by a virtualized destination. For example, any individual data packet segment received at a virtualized destination can be delivered to the destination VM of the virtualized destination, irrespective of which other data packet segments are received. In other words, the decapsulation layer in the hypervisor, or the decapsulation module of the virtualized destination can be state-less, in that a state of the sequence of received data packet segments is not needed to be maintained. The decapsulation module may also be provided in the hypervisor of the virtualized destination. For example, no state needs to be maintained in the kernel of the virtualized destination when receiving the data packet segments. These features can reduce CPU usage at both the virtualized source and the virtualized destination.

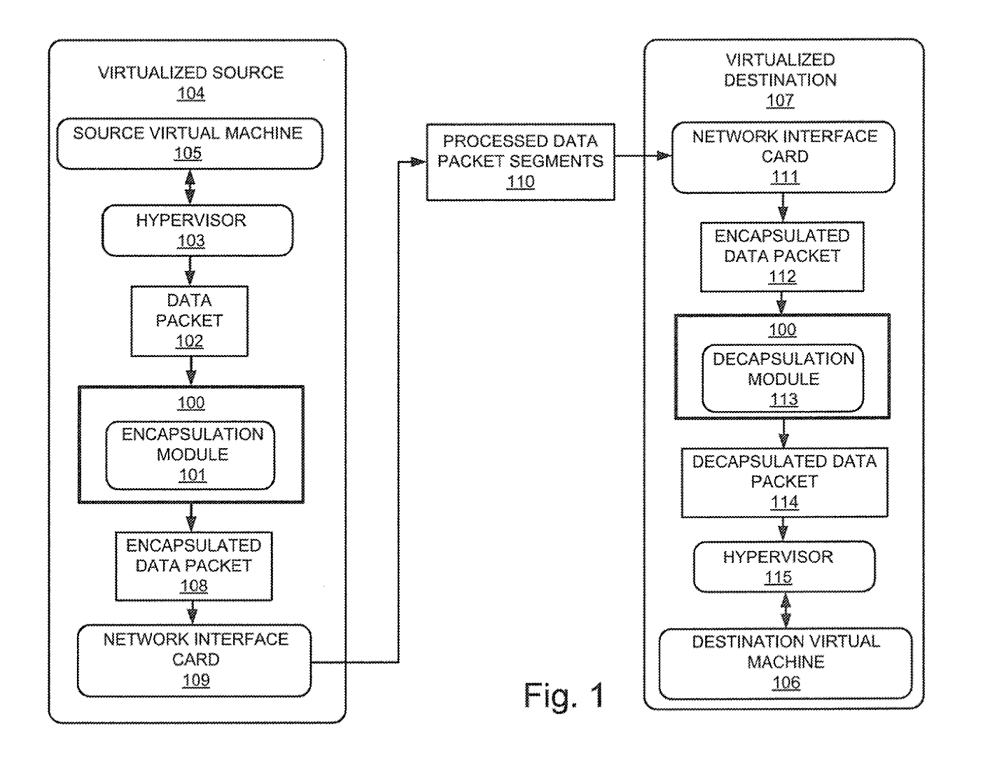

FIG. 1 illustrates an architecture of a virtual machine data packet encapsulation and decapsulation apparatus 100, according to an example. Referring to FIG. 1, the apparatus 100 is depicted as including an encapsulation module 101 that is to encapsulate a data packet 102 received from a hypervisor 103 of a virtualized source 104. The hypervisor 103 receives the data packet 102 from a source VM 105 hosted on the virtualized source 104. The data packet 102 is to be transmitted to a destination VM 106 hosted on a virtualized destination 107, which may be a destination virtualized host. An encapsulated data packet 108 is transmitted from the encapsulation module 101 to a NIC 109 that processes the encapsulated data packet 108 as described in further detail below. A plurality of processed data packet segments 110 are transmitted to a NIC 111 of the virtualized destination 107 for processing and transmission as an encapsulated data packet 112 to a decapsulation module 113, which further transmits a decapsulated data packet 114 to a hypervisor 115 to be received by the destination VM 106. The decapsulation module 113 may decapsulate the encapsulated data packet 112 from the NIC 111, and transmit a decapsulated data packet 114 to the hypervisor 115. The encapsulation module 101 may be provided as a component of the hypervisor 103 such that the encapsulated data packet 108 is transmitted directly from the hypervisor 103 to the NIC 109. Similarly, the decapsulation module 113 may be provided as a component of the hypervisor 115 such that the decapsulated data packet 114 is transmitted directly from the hypervisor 115 to the destination VM 106.

The modules 101 and 113, and other components of the apparatus 100 that perform various other functions in the apparatus 100, may comprise machine readable instructions stored on a computer readable medium. In addition, or alternatively, the modules 101 and 113, and other components of the apparatus 100 may comprise hardware or a combination of machine readable instructions and hardware.

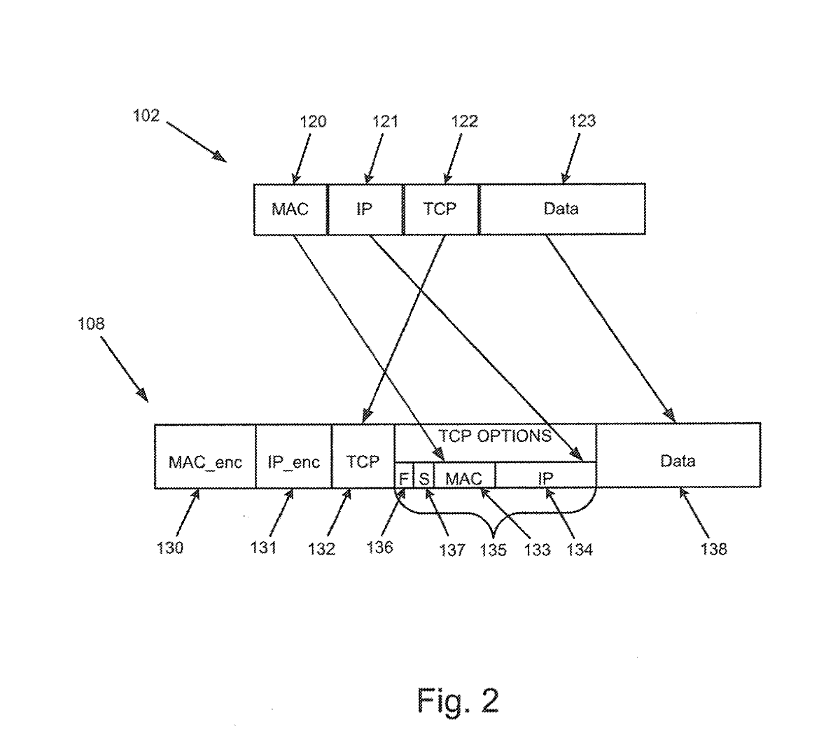

Referring to FIGS. 1 and 2, the data packet 102 includes a media access control (MAC) header 120 and an Internet protocol (IP) header 121. For certain data packets 102, the IP header 121 may be omitted, in which case the data packet 102 includes the MAC header 120. The MAC and IP headers are used to identify the destination VM 106 of the virtualized destination 107. The address provided by the MAC header 120 and/or the IP header 121 allows the hypervisor 115 of the virtualized destination 107 to route the data packet 102 to the correct destination VM 106. As shown in FIG. 2, the data packet 102 may further include a TCP header 122 and data 123.

The encapsulation module 101 encapsulates the data packet 102 to include an encapsulating MAC header 130, and an encapsulating IP header 131. The encapsulation module 101 may further encapsulate the data packet 102 to include a TCP header 132 with the same (or similar) content as the TCP header 122 of the data packet 102, after the encapsulating MAC header 130 and the encapsulating IP header 131. In this manner, the NIC 109 performs operations on the encapsulated data packet 108 as if the encapsulated data packet 108 is a non-encapsulated TCP packet as opposed to an encapsulated data packet. For example, once the NIC 109 receives the encapsulated data packet 108, the NIC 109 can perform TSO and checksumming operations, and forward the processed data packet segments 110 to the NIC 111 of the virtualized destination 107.

The encapsulation module 101 further encapsulates the data packet 102 to include VM MAC and VM IP headers with the encapsulating MAC header 130 and encapsulating IP header 131. As a first option, which is hereinafter denoted a TCP option, the encapsulation module 101 encapsulates the data packet 102 to include a VM MAC header 133 with the same (or similar) content as the MAC header 120 and a VM IP header 134 with the same (or similar) content as the IP header 121 in a TCP options field 135 of the TCP header 132. Specifically, the TCP header 132 includes a variable-bit field denoted TCP options where up to 40 bytes can be carried in a TCP packet. As per the standard defining the TCP protocol, the options field 135 includes a one byte key field “F” at 136 to describe the type of option carried in the TCP options field 135. The VM data packet encapsulation apparatus 100 uses a new option type for the field “F” at 136 to identify the VM MAC and IP headers. Further, a one byte size field “S” at 137 is used to describe the option size (i.e., the size of the VM MAC header 133 and the VM IP header 134), also as defined by the TCP standard. The encapsulated data packet 108 further includes data 138, which is the same as the data 123. Since the VM MAC header 133 and the VM IP header 134 generally span 34 bytes or 36 bytes if the MAC header has a VLAN tag field, these headers can fit into the 40 byte TCP options field 135. The NIC 109, which supports TSO and checksumming operations even for data packets including TCP options, thus processes the encapsulated data packet 108 as if the encapsulated data packet 108 is a non-encapsulated TCP packet.

The NIC 109 segments the encapsulated data packet 108 into MTU sized data packets (i.e., data packet segments) with the relevant header information. The NIC further creates headers such that each of the processed data packet segments 110 is a valid TCP packet that includes a sequence number, and includes a TCP options field. For the virtualized destination 107, since each MTU sized data packet segment includes the VM MAC header 133 and the VM lP header 134 in the TCP options field 135, each data packet segment can be forwarded to the TCP stack independently without the need to recreate the original larger size data packet 102. For example, since the receiving hypervisor 115 can determine the address of the destination VM 106 from the VM MAC header 133 and the VM IP header 134, each data packet segment can be forwarded to the destination VM 106 without using information from previous packets (in this case, the NIC 111 of the virtualized destination 107 does not combine the processed data packet segments 110 to form the encapsulated data packet 112). During processing of the encapsulated data packet 108, the NIC 109 also computes the transmit checksumming. When the processed data packet segments 110 are received by the virtualized destination 107, the receiving NIC 111 computes the checksum and compares it with the checksum in the processed data packet segments 110 to verify integrity.

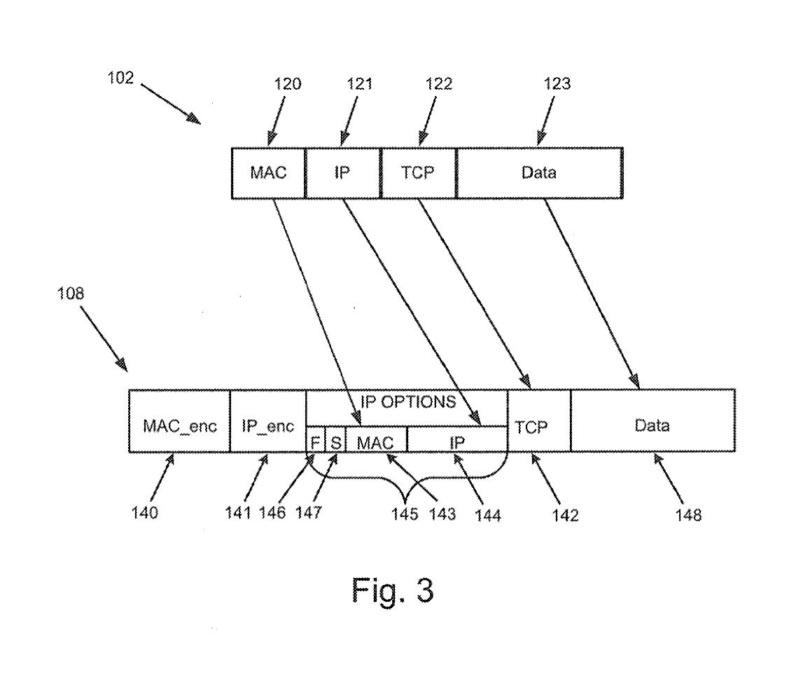

Referring to FIGS. 1 and 3, as a second option, hereinafter denoted an IP option, the encapsulation module 101 encapsulates the data packet 102 to include an encapsulating MAC header 140, and an encapsulating IP header 141. The encapsulation module 101 may further encapsulate the data packet 102 to include a TCP header 142 with the same content as the TCP header 122 of the data packet 102, after the encapsulating MAC header 140 and the encapsulating IP header 141. The encapsulation module 101 further encapsulates the data packet 102 to include VM MAC and VM lP headers with the encapsulating MAC header 140 and the encapsulating IP header 141. For the IP option, the encapsulation module 101 encapsulates the data packet 102 to include a VM MAC header 143 with the same (or similar) content as the MAC header 120 and a VM IP header 144 with the same (or similar) content as the lP header 121 in an IP options field 145 of the encapsulating IP header 141. Specifically, the encapsulating IP header 141 includes a variable-bit field denoted IP options where up to 40 bytes can be carried in a TCP packet. For the IP options field 145, a one byte key field “F” at 146 describes the type of option carried in the IP options field 145. The VM data packet encapsulation apparatus 100 uses a new option type for the field “F” at 146 to identify the VM MAC and IP headers. Further, a one byte size field “S” at 147 is used to describe the option size (i.e., the size of the VM MAC header 143 and the VM IP header 144). The encapsulated data packet 108 further includes data 148, which is the same as the data 123. Since the VM MAC header 143 and the VM IP header 144 generally span 34 bytes or 36 bytes if the MAC header has a ULAN tag field, these headers can fit into the 40 byte IP options field 145. The NIC 109, which supports TSO and checksumming operations even for data packets including IP options, thus processes the encapsulated data packet 108 as if the encapsulated data packet 108 is a non-encapsulated TCP packet.

Since all fields in an encapsulating IP header may not be needed for address virtualization (e.g., IP identification (ID)), some of the information from the VM IP header may be encoded into an outer IP header. This reduces the space used for the TCP options field 135 and the IP options field 145 to less than 34 bytes.

The decapsulation module 113 may decapsulate the encapsulated data packet 112 from the NIC 111, and transmit a decapsulated data packet 114 to the hypervisor 115. The decapsulation module 113 may be state-less, in that a state of the sequence of received data packet segments does not need to be maintained. For example, if the NIC 111 does not combine the processed data packet segments 110 to form the encapsulated data packet 112, the decapsulation module 113 may nevertheless receive one or more processed data packet segments 110, decapsulate the received data packet segments 110, and forward the decapsulated data packet segments to the hypervisor 115 for forwarding to the destination VM 106. The decapsulation module 113 may decapsulate the encapsulated data packet 112 (or the received data packet segments 110) from the NIC 111 by removing the encapsulating MAC header 130 and the encapsulating IP header 131, and inserting the VM MAC header 133 and VM IP header 134 in the respective locations of the encapsulating MAC header 130 and the encapsulating IP header 131.

Based on the foregoing, any data packet segment from the processed data packet segments 110 received at the virtualized destination 107 can be delivered to the destination VM 106, irrespective of any other data packet segments received or lost. As a consequence, the decapsulation module 113 of the virtualized destination 107 can be stateless, in that a state of the sequence of received data packet segments does not need to be maintained. Further, for a system that uses either the VM MAC header 133 (or 143) or the VM IP header 134 (or 144) for data packet transmission, the appropriate VM header may be included in the encapsulated data packet 108. The VM MAC header 133 (or 143) and the VM IP header 134 (or 144) may also be disposed at other locations of the encapsulated data packet 108 based on space availability.

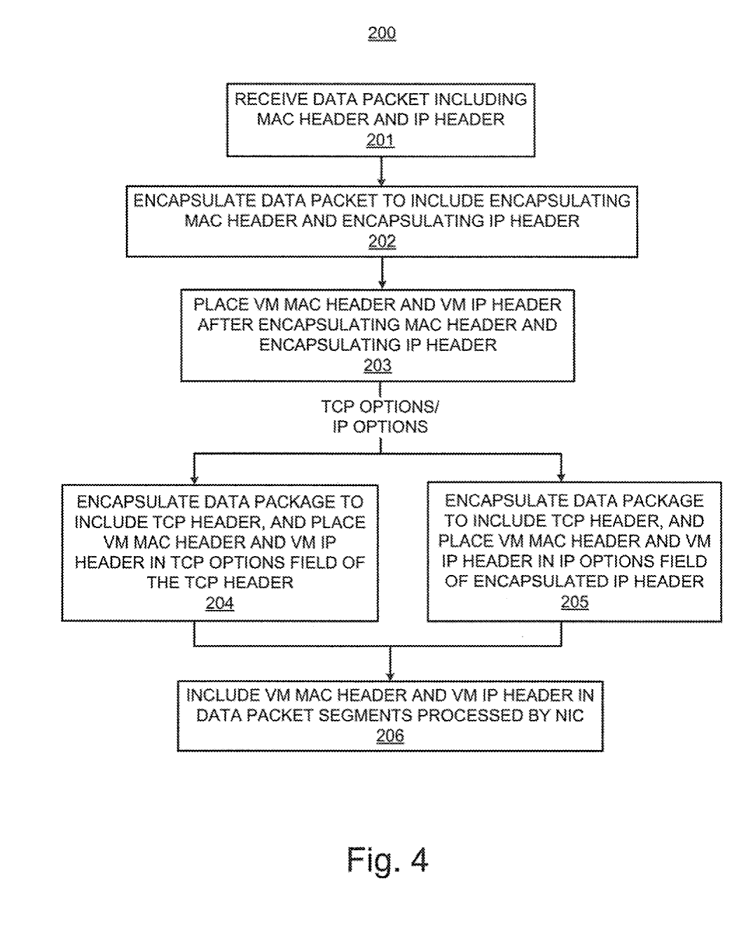

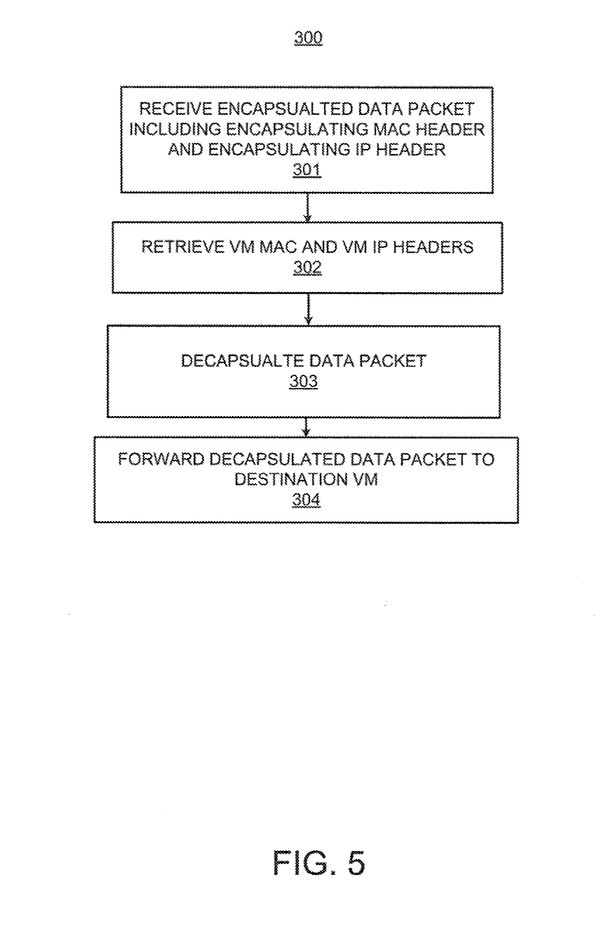

FIGS. 4 and 5 illustrate flowcharts of method 200 and 300 for virtual machine data packet encapsulation and decapsulation, corresponding to the example of the virtual machine data packet encapsulation and decapsulation apparatus 100 whose construction is described in detail above. The methods 200 and 300 may be implemented on the virtual machine data packet encapsulation and decapsulation apparatus 100 with reference to FIG. 1 by way of example and not limitation. The methods 200 and 300 may be practiced in other apparatus.

Referring to FIG. 4, for the method 200, at block 201, a data packet including a MAC header and an IP header is received. Alternatively, a data packet including a MAC header or an IP header may be received. For example, referring to FIG. 1, a data packet 102 is received from the hypervisor 103 of the virtualized source 104.

At block 202, the received data packet is encapsulated to include an encapsulating MAC header, an encapsulating IP header, a VM MAC header with the same (or similar) content as the MAC header of the received data packet, and a VM IP header with the same (or similar) content as the IP header of the received data packet. In some cases, the encapsulating IP header may be omitted. For example, referring to FIGS. 1 and 2, the encapsulation module 101 encapsulates the data packet 102 to include the encapsulating MAC header 130, the encapsulating IP header 131, the VM MAC header 133 with the same (or similar) content as the MAC header 120 of the received data packet 102, and the VM IP header 134 with the same (or similar) content as the IP header 121 of the received data packet 102. FIG. 3 also shows similar features as discussed above.

At block 203, the VM MAC header and the VM IP header are placed after the encapsulating MAC header and the encapsulating IP header. For example, referring to FIGS. 1 and 2, the VM MAC header 133 and the VM IP header 134 are placed after the encapsulating MAC header 130 and the encapsulating IP header 131. FIG. 3 also shows similar features as discussed above.

At block 204, the received data packet is encapsulated to include a TCP header with a same (or similar) content as a TCP header of the received data packet, and the VM MAC header and the VM IP header are placed in a TCP options field of the TCP header of the encapsulated data packet. For example, referring to FIGS. 1 and 2, the received data packet 102 is encapsulated to include the TCP header 132 with a same (or similar) content as the TCP header 122 of the received data packet 102, and the VM MAC header 133 and the VM IP header 134 are placed in the TCP options field 135 of the TCP header 132 of the encapsulated data packet 108. Further, the key field 136 that describes an option carried in the TCP options field 135, and the size field 137 that describes a size of the VM MAC header 133 and the VM IP header 134 are included.

At block 205, alternatively, the packet is encapsulated to include a TCP header with a same (or similar) content as a TCP header of the received data packet, and the VM MAC header and the VM IP header are placed in an IP options field of the encapsulating IP header. For example, referring to FIGS. 1 and 3, the VM MAC header 143 and the VM IP header 144 are placed in the IP options field 145 of the encapsulating IP header 141. Further, the key field 146 that describes an option carried in the IP options field 145, and the size field 147 that describes a size of the VM MAC header 143 and the VM IP header 144 are included.

At block 206, the VM MAC header and the VM IP header are included in data packet segments processed by the NIC. For example, referring to FIGS. 1-3, the VM MAC header 133 (or 143), and the VM IP header 134 (or 144) are included in data packet segments 110 processed by the NIC 109 in the header of the data packet segments 110. The NIC 109 is also used to perform ISO and checksumming operations on the encapsulated data packet 108.

Referring to FIG. 5, for the method 300, at block 301, an encapsulated data packet including an encapsulating MAC header and an encapsulating IP header is received. For example, referring to FIGS. 1 and 2, the encapsulated data packet 112 including the encapsulating MAC header 130 and the encapsulating IP header 131 is received.

At block 302, the VM MAC and VM IP headers are retrieved from the encapsulated data packet. For example, referring to FIGS. 1 and 2, the decapsulation module 113 retrieves the VM MAC and VM IP headers from the encapsulated data packet 112.

At block 303, the encapsulated data packet is decapsulated. For example, referring to FIGS. 1-3, the decapsulation module 113 decapsulates the encapsulated data packet 112 by removing the encapsulating MAC header 130 and the encapsulating IP header 131, and inserting the VM MAC header 133 and VM IP header 134 in the respective locations of the encapsulating MAC header 130 and the encapsulating IP header 131. Alternatively, the encapsulated data packet is transmitted to a NIC of a virtualized source, processed data packet segments are transmitted from the NIC of the virtualized source to a NIC of a virtualized destination, and a state-less decapsulation layer in a hypervisor of the virtualized destination is used to receive the processed data packet segments from the NIC of the virtualized destination, and to further process and transmit the processed data packet segments to a destination VM on the virtualized destination. For example, referring to FIG. 1, if the decapsulation module 113 is provided in the hypervisor 115 and the NIC 111 does not combine the processed data packet segments 110 to form the encapsulated data packet 112, a state-less decapsulation layer in the hypervisor 115 of the virtualized destination 107 is used to receive the processed data packet segments 110 from the NIC 111, and further process and transmit the processed data packet segments 110 to the destination VM 106 on the virtualized destination 107. Further, a data packet segment is transmitted to a destination VM on the virtualized destination independently of other processed data packet segments. For example, referring to FIG. 1, a data packet segment is transmitted to the destination VM 106 on the virtualized destination 107 independently of other processed data packet segments 110. Alternatively, the encapsulated data packet 108 is transmitted to the NIC 109, processed data packet segments are received from the NIC 111, and the processed data packet segments are decapsulated by the decapsulation module 113 to replace the encapsulating MAC header with the VM MAC header, and the encapsulating IP header with the VM IP header.

At block 304, the decapsulated data packet is forwarded to a destination VM. For example, referring to FIG. 1, the decapsulated data packet 114 is forwarded to the hypervisor 115, which forwards the decapsulated data packet 114 to the destination VM 106. As noted herein, the decapsulated data packet 114 may represent the original data packet 102 (i.e., with all processed data packet segments combined to form the encapsulated data packet 112) or certain data packet segments of the original data packet 102 that are received by the NIC 111.

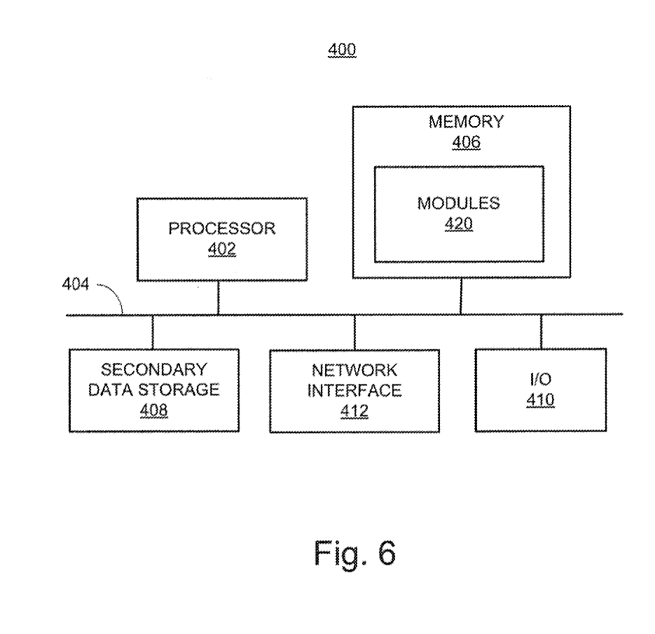

FIG. 6 shows a computer system that may be used with the examples described herein. The computer system represents a generic platform that includes components that may be in a server or another computer system. The computer system may be used as a platform for the apparatus 100. The computer system may execute, by a processor or other hardware processing circuit, the methods, functions and other processes described herein. These methods, functions and other processes may be embodied as machine readable instructions stored on a computer readable medium, which may be non-transitory, such as hardware storage devices (e.g., RAM (random access memory), ROM (read only memory), EPROM (erasable, programmable ROM), EEPROM (electrically erasable, programmable ROM), hard drives, and flash memory).

The computer system includes a processor 302 that may implement or execute machine readable instructions performing some or all of the methods, functions and other processes described herein. Commands and data from the processor 402 are communicated over a communication bus 404. The computer system also includes a main memory 406, such as a random access memory (RAM), where the machine readable instructions and data for the processor 402 may reside during runtime, and a secondary data storage 408, which may be non-volatile and stores machine readable instructions and data. The memory and data storage are examples of computer readable mediums. The memory 406 may include modules 420 including machine readable instructions residing in the memory 406 during runtime and executed by the processor 402. The modules 420 may include the modules 101 and 113 of the apparatus shown in FIG. 1.

The computer system may include an I/O device 410, such as a keyboard, a mouse, a display, etc. The computer system may include a network interface 412 for connecting to a network. Other known electronic components may be added or substituted in the computer system.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A method for virtual machine (VM) data packet encapsulation and decapsulation, the method comprising:
receiving a data packet including a media access control (MAC) header and an Internet protocol (IP) header; and
encapsulating, by a processor, the received data packet to include an encapsulating MAC header, an encapsulating IP header, a VM MAC header with a same content as the MAC header of the received data packet, and a VM IP header with a same content as the IP header of the received data packet.

2. The method of claim 1, further comprising:
placing the VM MAC header and the VM IP header after the encapsulating MAC header and the encapsulating IP header.

3. The method of claim 1, further comprising:
encapsulating the received data packet to include a transmission control protocol (TCP) header with a same content as a TOP header of the received data packet; and
placing the VM MAC header and the VM IP header in a TOP options field of the TOP header of the encapsulated data packet.

4. The method of claim 3, further comprising:
including a key field that describes a type of option carried in the TOP options field.

5. The method of claim 3, further comprising:
including a size field that describes a size of the VM MAC header and the VM IP header.

6. The method of claim 1, further comprising:
placing the VM MAC header and the VM IP header in an IP options field of the encapsulating IP header.

7. The method of claim 6, further comprising:
including a key field that describes a type of option carried in the IP options field.

8. The method of claim 6, further comprising:
including a size field that describes a size of the VM MAC header and the VM IP header.

9. The method of claim 1, further comprising:
including the VM MAC header and the VM IP header in headers of data packet segments processed by a network interface card (NIC).

10. The method of claim 1, further comprising:
transmitting the encapsulated data packet to a network interface card (NIC) of a virtualized source;
transmitting processed data packet segments from the NIC of the virtualized source to a NIC of a virtualized destination; and
using a state-less decapsulation layer in a hypervisor of the virtualized destination to receive the processed data packet segments from the NIC of the virtualized destination, and to further process and transmit the processed data packet segments to a destination VM on the virtualized destination.

11. The method of claim 1, further comprising:
transmitting the encapsulated data packet to a network interface card (NIC) of a virtualized source;
transmitting a processed data packet segment from the NIC of the virtualized source to a NIC of a virtualized destination;
receiving the processed data packet segment from the NIC of the virtualized destination; and
transmitting the data packet segment to a destination VM on the virtualized destination independently of other processed data packet segments.

12. The method of claim 1, further comprising:
using a network interface card (NIC) to perform transmission control protocol (TCP) segmentation offload (TSO) and checksumming operations on the encapsulated data packet.

13. The method of claim 1, further comprising:
transmitting the encapsulated data packet to a network interface card (NIC) of a virtualized source;
receiving the encapsulated data packet from a NIC of a virtualized destination; and
decapsulating the encapsulated data packet to replace the encapsulating MAC header with the VM MAC header, and the encapsulating IP header with the VM IP header.

14. A virtual machine (VM) data packet encapsulation and decapsulation apparatus comprising:
a memory storing a module comprising machine readable instructions to:
receive a data packet including a media access control (MAC) header and an internet protocol (IP) header;
encapsulate the received data packet to include an encapsulating MAC header, an encapsulating IP header, a VM MAC header with a same content as the MAC header of the received data packet, and a VM IP header with a same content as the IP header of the received data packet; and
one of:
encapsulate the received data packet to include a transmission control protocol (TCP) header with a same content as a TCP header of the received data packet, and place the VM MAC header and the VM IP header in a TCP options field of the TCP header of the encapsulated data packet, and
place the VM MAC header and the VM IP header in an IP options field of the encapsulating IP header; and
a processor to implement the module.

15. A non-transitory computer readable medium having stored thereon machine readable instructions for virtual machine (VM) data packet encapsulation and decapsulation, the machine readable instructions when executed cause a computer system to:
receive a data packet including one of a media access control (MAC) header and an internet protocol (IP) header; and
encapsulate, by a processor, the received data packet to include one of an encapsulating MAC header and an encapsulating IP header, and one of a VM MAC header with a same content as the MAC header of the received data packet, and a VM IP header with a same content as the IP header of the received data packet.
